(19) United States
(12) Patent Application Publication
(10) Pub. No.: US 2002/0104367 A1
(43) Pub. Date: Aug. 8, 2002

(54) Method and device for classifying a person sitting on a vehicle seat

(76) Inventors: Thomas Lich, Schwaikheim (DE); Frank Mack, Stuttgart (DE)

Correspondence Address: KENYON & KENYON, ONE BROADWAY, NEW YORK, NY, 10004, US

(21) Appl. No.: 09/962,398

(22) Filed: Sep. 24, 2001

(30) Foreign Application Priority Data
Sep. 23, 2000 (DE) 100 47 192.7-34

(51) Int. Cl. G01G 23/01

(52) U.S. Cl. 73/1.13

(57) ABSTRACT

A method and a device are proposed for classifying a person sitting on a vehicle seat, which are used to combine a weight estimation based on a seat profile of a person, with a further feature, preferably the distance between the ischium tuberosities, in order to carry out a person classification. The weight estimation is further improved by a temperature correction, either a stored characteristic curve or a correction factor being used in light of a temperature value for the temperature correction. The seat mat is divided into area elements for the weight estimation, the weight pressure being ascertained per area element and the weight estimation being carried out from that.

### FIELD OF THE INVENTION

The present invention is based on a method and a device, respectively, for classifying a person sitting on a vehicle seat.

### BACKGROUND INFORMATION

U.S. Pat. No. 5,975,565 already describes that, for an occupant-restraint system, to determine the weight for a person located on the vehicle seat with the aid of pressure-responsive sensors. In that case, the weight determination is first triggered by a minimum weight of the person.

### SUMMARY OF THE INVENTION

In contrast, the method and the device of the present invention for classifying a person sitting on a vehicle seat have the advantage that an improved person classification is possible, which means more safety and reliability for the use of an occupant-restraint system. In particular, the combination of the weight estimation with a further feature permits a more accurate classification of the person on the vehicle seat.

It is advantageous that the absolute weight of the object on the seat mat by subdividing the seat mat into area elements, determining the weight pressure per area element and summing up the weights per area element. This permits a very simple method for determining the weight. The weight of a person is of crucial importance for an occupant-restraint system, because the restraint force used by the occupant-restraint system (airbag, belt tightener) goes by it. In this context, in one further development it is advantageous that a prestress with respect to the weight pressure is adjustable for the individual area elements in order to take into account a compressive load due to the installation.

It is particularly advantageous that, as the further feature, the distance between the ischium tuberosities of the person is determined, so that by the combination of the weight estimation and the ischium-tuberosity spacing, complementary information is used for characterizing the person. The distance between the ischium tuberosities indicates the dimension of the person, while the weight estimation characterizes the condition of the person. An extremely precise person classification is thereby made possible.

It is also advantageous that increased robustness with respect to environmental influences is attained by a temperature correction of the weight estimation. In this context, either a stored characteristic curve or a correction factor is used by the value of a temperature sensor for the temperature correction of the weight estimation.

### BRIEF DESCRIPTION OF THE DRAWINGS

FIG. 1 shows a block diagram of the device according to the present invention.

FIG. 2 shows a flow chart of the method according to the present invention.

### DETAILED DESCRIPTION

Due to the increasing use of occupant-restraint systems in motor vehicles, it is becoming ever more important to classify the persons on the vehicle seats in order to permit optimal use of the restraint system. Of primary importance is that the restraint systems cause no harm to the persons on the vehicle seats. It is also important that the restraint systems offer optimal protection for the passengers in the event of a vehicle crash.

Therefore, according to the present invention, a person classification is carried out in the light of a weight estimation and at least one further feature yielded from the seat profile. The spacing of the ischium tuberosities, which is yielded from the seat profile, is advantageously used as the further feature. The weight estimation is further improved by a temperature correction, either a stored characteristic curve or a correction factor being used for the temperature correction. The characteristic curve and the correction factor, respectively, are selected with reference to a value of a temperature sensor. Here, the weight estimation is calculated in terms of the weight pressure per predefined area element of the seat mat. Consequently, a very simple method is realized for estimating the absolute weight of an object on a vehicle seat.

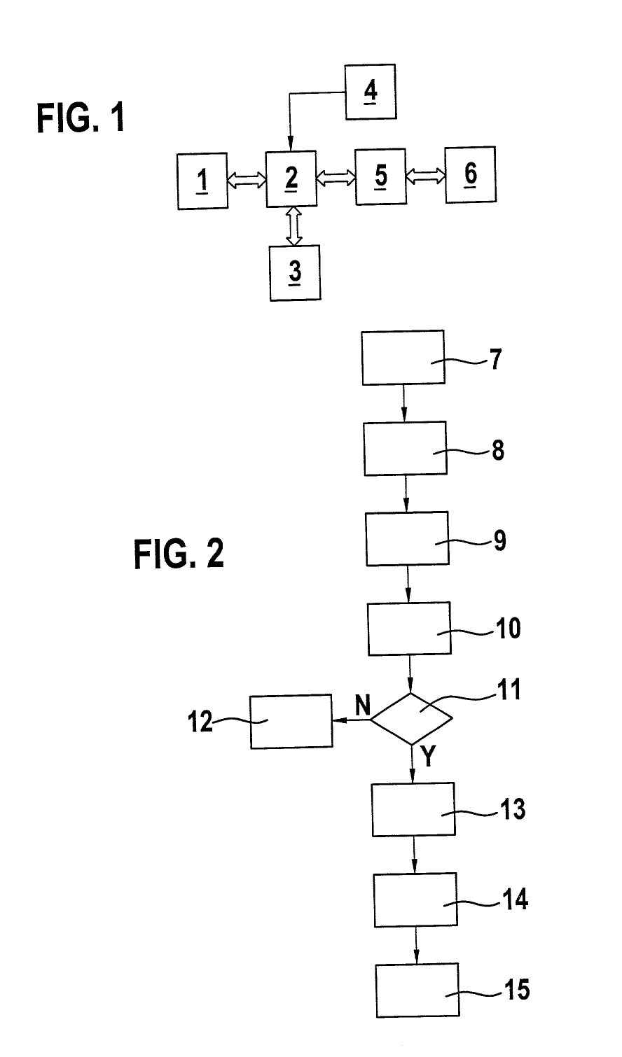

FIG. 1 shows the device of the present invention as a block diagram. A seat mat 1 having a matrix of pressure sensors supplies sensor values via a first data input/output to a processor 2 that is connected via a second data input/output to a memory 3, via a third data input/output to a control device 5 for the occupant-restraint system, and via a data input to a temperature sensor 4. Control device 5 is connected via a second data input/output to an occupant-restraint system 6. Processor 2 and memory 3 are accommodated in one housing and form a control unit for seat mat 1.

Seat mat 1 supplies the individual sensor values sequentially as current values to processor 2, sensor mat 1 having an analog-digital converter which digitalizes these current values. The pressure sensors are arranged in a matrix. Processor 2 applies voltages to the rows and columns, so that according to the principle of the balanced bridge, initially no currents flow through the pressure sensors. In response to an increased pressure, the pressure sensors exhibit a slight resistance. If processor 2 now measures the individual pressure sensors in the sensor matrix, then processor 2 changes the voltages applied to the rows and columns so that a current flows through a specific pressure sensor. This current is measured, digitalized by the analog-digital converter and then transmitted to processor 2. Processor 2 calculates the resistances of the individual pressure sensors from the current values.

From the individual resistance values, processor 2 then calculates a seat profile corresponding to the added load pressure, in order to estimate the weight of the person sitting on the vehicle seat on the basis of this seat profile. For that purpose, seat mat 1 is divided into area elements. Here, one pressure sensor is in one area element. The weight pressure measured by the pressure sensor, expressed by the calculated resistance value, is assumed as constant over the area element. Alternatively, it is possible to accommodate a plurality of pressure sensors in one area element, to then indicate an average value for the weight pressure for this area element. The weight pressure is equal to the force per area. The resistance value of the pressure sensor is converted by a predetermined equation into a weight pressure. Multiplication with the area element yields the force or the weight on this area element. If all weights for the individual area elements are summed up, this then yields the total weight of the person or the object on the vehicle seat.

With reference to the seat profile, the distance between the ischium tuberosities of the person on the vehicle seat is furthermore determined, to thus ascertain the further feature. Processor 2 then classifies the person in terms of the ischium tuberosity spacing and the weight, with the aid of values stored in memory 3. Processor 2 transmits the person classification to control device 5, which in the event of a vehicle crash, consequently triggers the occupant-restraint system corresponding to the classified person. Furthermore, control device 5 routinely carries out diagnostic cycles for occupant-restraint system 6 composed of various airbags and belt tighteners.

Processor 2 receives the instantaneous temperature from temperature sensor 4. Since the sensors in seat mat 1 exhibit a temperature dependency, processor 2 corrects the sensor data, thus the current values or later the resistance values, in light of the temperature value from temperature sensor 4. Here, there are two possibilities for this purpose: First of all, with reference to the temperature value, processor 2 selects a correction characteristic curve from memory 3 to thereby weight and thus to correct the weight estimation. Secondly, in light of the temperature value, processor 2 determines a correction factor by which the weight estimation is multiplied in order to implement the correction. The connection between temperature sensor 4 and processor 2 can be implemented via a CAN (controller area network) bus which is suitable for transmitting sensor values in the vehicle. The stored characteristic curves are saved in memory 3 in such a way that a corresponding characteristic curve is used for different temperature ranges. The correction factor for the temperature correction is calculated in light of a predefined function which is likewise stored in memory 3.

FIG. 2 shows the method of the present invention as a flow chart. In method step 7, the sensor values from seat mat 1 are acquired, digitalized and transmitted to processor 2. In method step 8, using the sensor values, processor 2 carries out a weight estimation as described above. In method step 9, the temperature correction is implemented by processor 2 with the aid of a temperature value from temperature sensor 4. Here, in so doing, with reference to the temperature value, a correction characteristic curve from memory 3 is loaded with which the weight estimation is corrected. Alternatively, it is possible to determine a correction factor from the ascertained temperature. In method step 10, from the sensor values, processor 2 generates a seat profile from which processor 2 determines the ischium tuberosity spacing. From the seat profile, it is determined in method step 11 whether or not it is a person. If it is not a person, then the method of the present invention terminates in method step 12, since no restraint system is triggered for a thing, e.g. a box. However, if a person is sitting on the vehicle seat, then in method step 13, the distance between the ischium tuberosities is determined, in order to then be combined with the weight estimation. With that, the person classification is then carried out in method step 14, a classification being made in light of the ischium tuberosity spacing and the weight. In method step 15, the person classification is transmitted to control device 5 of the occupant-restraint system, so that control device 5 optimally triggers occupant-restraint system 6 in the event of a crash.

The person classification can also be transferred to other vehicle systems.

What is claimed is:

1. A method for evaluating a sensor signal of a seat mat of a vehicle seat, comprising the steps of:
causing a sensor in the seat mat to supply the sensor signal corresponding to a weight pressure added to the vehicle seat;
generating a seat profile of the vehicle seat in accordance with the sensor signal; and
performing a person classification in accordance with a weight estimation of a person sitting on the vehicle seat and at least one further feature of the seat profile.

2. The method according to claim 1, further comprising the steps of:
dividing the seat mat into area elements;
determining the weight pressure per area element; and
ascertaining the weight estimation from the determined weight pressure.

3. The method according to claim 2, wherein:
predefined for the area elements are specific weight-pressure thresholds, and
the step of determining the weight pressure is performed in accordance with an exceeding of the weight-pressure thresholds.

4. The method according to claim 1, wherein:
a spacing of an ischium tuberosity is ascertained from the seat profile as the at least one further feature.

5. The method according to claim 1, wherein:
the weight estimation is subject to a temperature correction.

6. The method according to claim 5, further comprising the steps of:
performing the temperature correction in accordance with a stored characteristic curve and a temperature value from a temperature sensor; and
performing the weight estimation in accordance with the seat profile and the stored characteristic curve.

7. The method according to claim 5, further comprising the step of:
performing the temperature correction in accordance with a correction factor for the weight estimation and a temperature value from a temperature sensor.

8. A device for classifying a person sitting on a vehicle seat, comprising:
a seat mat including a sensor;
a processor for ascertaining a seat profile of the vehicle seat from a sensor signal; and
a memory, wherein:
the processor performs a weight estimation in accordance with the seat profile, and
the processor classifies the person in accordance with the weight estimation and at least one further feature that the processor determines from the seat profile.

9. The device according to claim 8, wherein:
from the sensor signal, the processor ascertains an ischium tuberosity spacing as the at least one further feature.

10. The device according to claim 8, further comprising:
a temperature sensor, wherein:
the processor corrects the weight estimation with a signal from the temperature sensor.

11. The device according to claim 10, further comprising:
a bus for connecting the processor to the temperature sensor.

12. The device according to claim 10, wherein:
the memory includes a characteristic curve that the processor selects as a function of the signal from the temperature sensor for performing the weight estimation.

13. The device according to claim 10, wherein:
the processor determines a correction factor for the weight estimation from the signal of the temperature sensor.
